(19) United States
(12) Patent Application Publication
(10) Pub. No.: US 2026/0158729 A1
(43) Pub. Date: Jun. 11, 2026

(54) EXTRUDER DIE ASSEMBLY

(71) Applicant: HEARTLAND TOOL WORKS, INC., Poplar Bluff, MO (US)

(72) Inventor: Ken Owens, Poplar Bluff, MO (US)

(21) Appl. No.: 19/181,183

(22) Filed: Apr. 16, 2025

Related U.S. Application Data
(60) Provisional application No. 63/634,552, filed on Apr. 16, 2024.

(51) Int. Cl. B29C 48/154; B29C 48/30; B29L 31/34; H01B 19/04

(52) U.S. Cl. CPC B29C 48/154; B29C 48/30; H01B 19/04; B29L 2031/3462

(57) ABSTRACT

An extruder die assembly for coating wires is disclosed. The extruder die assembly includes a head, a wire guide, and a die. The head includes an injection gate. The die has a guide receiving area. The wire guide has wire grooves arranged in a side-by-side relationship and parallel to each other while being spaced relative to each other. The wire guide inserts in the die. The die inserts in the axial opening of the head. The head receives wires through the axial opening. The injection gate receives molten plastic that gets distributed around the wires which are moved axially within the axial opening. The coated wires exit through the die while being arranged in a side-by-side contiguous relationship to provide contact areas between adjacent coated wires.

### CROSS REFERENCE TO RELATED APPLICATIONS

The present application claims the benefit of U.S. Provisional Application No. 63/634,552, filed Apr. 16, 2024; all of which is incorporated herein in its entirety and referenced thereto.

### FIELD OF THE INVENTION

The present invention relates to an extruder die assembly. More specifically, the present invention relates to an extruder die assembly for coating wires.

### BACKGROUND OF THE INVENTION

It is known that wires or cables are coated with a protective layer in order to provide insulation, mechanical protection and sometimes to identify them with color coding. For example, a plastic insulating layer is coated over an electrical wire to prevent electrical leakage and ensure safety. Typically, the wire coating process involves use of extrusion apparatus or cross-head and a die. In operation, one or more electrical wires or other elongated members are moved axially through the extrusion apparatus. A flowable coating material is injected into the extrusion apparatus and the coating material is applied to the electrical wire as it exits the extrusion apparatus via the die. With improvements in technology, multiconductor cable assemblies having multiple conductors enclosed within a single cable jacket are preferred. The cable assemblies are used in a variety of applications such as electronics, telecommunications, industrial automation, etc.

Several methods of making multiconductor cable assemblies have been disclosed in the past. Once such method is disclosed in a U.S. Pat. No. 7,989,701, entitled “Multiconductor cable assembly and fabrication method therefor” (“the '701 Patent”). The '701 Patent discloses a multiconductor cable assembly including two or more coated wires in a side-by-side contacting relation, and the covering of the wires includes a composition with specific proportions of a poly(arylene ether), a block copolymer, and a flame retardant. The multiconductor cable assembly can be formed by extrusion coating two or more uncoated conductors, or by passing two or more coated wires through a nip defined by two rollers to fuse the coated wires.

Another method is disclosed in a United States Publication No. 20100219555, entitled “Method for extrusion of multi-layer coated elongate member” (“the '555 Publication”). The '555 Publication discloses a method of making a multi-layer insulated elongate member. The method includes providing an elongate member and tube extruding a first thermoplastic material onto an outer surface of the elongate member to create a first layer having a thickness less than or equal to 0.064 mm (0.0025 inch) using a first extruder apparatus. The method further includes using a second extruder apparatus for pressure extruding a compound comprising a second thermoplastic material different from the first thermoplastic material onto an outer surface of the first layer to create a second layer. The second layer fully wets the first layer and the flow point of the first thermoplastic material is at least 30° C. greater than the extrusion melt temperature of the second thermoplastic material.

Yet another method is disclosed in a U.S. Pat. No. 7,332,677, entitled “Multiconductor cable assemblies and methods of making multiconductor cable assemblies” (“the '677 Patent”). The '677 Patent discloses a multiconductor cable assembly and a method of making a multiconductor cable assembly are disclosed. The multiconductor cable assembly comprises a conductor and a covering comprising a thermoplastic composition. The thermoplastic composition comprises a poly(arylene ether), a polyolefin and a polymeric compatibilizer. The thermoplastic composition may further comprise a flame retardant.

Although the above discussed disclosures and other known methods are useful, they have few problems. For instance, some of the multiconductor cable assemblies need to be adjusted repeatedly to ensure the wires are properly coated and/or aligned. This increases the overall time needed to coat the wires. Further, the exiting multiconductor cable assemblies involve a lot of components making them difficult to operate.

Therefore, there is a need in the art for providing an improved extruder die assembly capable of providing two or more coated wires in a side-by-side contiguous relationship to provide one or more substantially interfacing contact areas between adjacent coated wires.

### SUMMARY OF THE INVENTION

It is an object of the present subject matter to provide an improved extruder die assembly that avoids the drawbacks of known multiconductor cable assemblies.

It is another object of the present subject matter to provide an extruder die assembly having a fixed center multi conductor tool that avoids the repeated adjustment of the components.

In order to overcome one or more objects, the present subject matter presents an extruder die assembly for coating wires. The extruder die assembly includes a head, a wire guide, and a die. The head includes an injection gate. The die has a guide receiving area. The wire guide has wire grooves arranged in a side-by-side relationship and parallel to each other while being spaced relative to each other. The wire guide inserts in the die. The die inserts in the axial opening of the head. The head receives wires through the axial opening. The injection gate receives molten plastic that gets distributed around the wires which are moved axially within the axial opening. The coated wires exit through the die while being arranged in a side-by-side contiguous relationship to provide contact areas between adjacent coated wires.

In one embodiment, the wire guide receiving area has a slightly larger area than the surface area of the wire guide. As a result, a gap is formed therebetween the wire guide and the wire guide receiving area when the wire guide sits within the die. The gap allows the molten plastic to flow around the wire guide and exit.

In one advantageous feature of the present subject matter, the wire guide is inserted in the die, which in turn positions in the head with the help of alignment members. The alignment members help to position the wire guide in a fixed manner within the die. This ensures that the wire guide needs to be set up only once. As a result, there is no need to adjust the position of the wire guide or die as in the prior art.

In another advantageous feature of the present subject matter, the wire grooves are arranged in a side-by-side relationship and parallel to each other while being spaced relative to each other. This makes the exiting coated wires to arrange in a side-by-side contiguous relationship to provide contact areas between adjacent coated wires.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

A more complete understanding of the invention and its many advantages thereof will be readily appreciated as the same becomes better understood by reference to the following detailed description, when considered in connection with the accompanying drawings wherein:

FIG. 1A and FIG. 1B illustrates a top view and a side view, respectively of an extruder die assembly, in accordance with one embodiment of the present subject matter;

FIG. 2A and FIG. 2B illustrates a top and a side view, respectively of a cross-head, in accordance with one embodiment of the present subject matter;

FIG. 3 illustrates a side view of a wire guide, in accordance with one embodiment of the present subject matter;

FIG. 4A and FIG. 4B illustrates a side view and a rear view, respectively of a support member, in accordance with one embodiment of the present subject matter;

FIG. 5A and FIG. 5B illustrates a front view and a side view, respectively of a cover plate, in accordance with one embodiment of the present subject matter;

FIG. 6 illustrates a cross-sectional view an extruder die assembly, in accordance with another embodiment of the present subject matter;

FIG. 7 illustrates a cross-sectional view a die, in accordance with another embodiment of the present subject matter; and

FIG. 8 illustrates a cross-sectional view of a wire guide, in accordance with another embodiment of the present subject matter.

### DETAILED DESCRIPTION

The following detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed extruder die assembly. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed extruder die assembly.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter provides a description of an extruder die assembly, it is to be further understood that numerous changes may arise in the details of the embodiments of the extruder die assembly. It is contemplated that all such changes and additional embodiments are within the spirit and true scope of this disclosure.

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure.

Various features and embodiments of an extruder die assembly are explained in conjunction with the description of FIGUREs (FIGS.) 1-8.

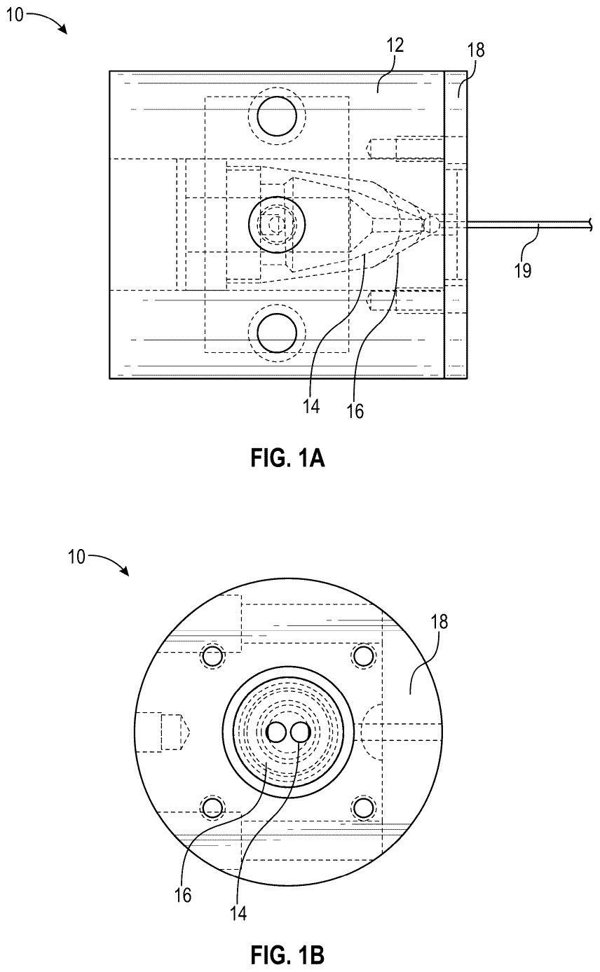

FIG. 1A and FIG. 1B show a top view and a side view, respectively of an extruder die assembly 10, in accordance with one embodiment of the present subject matter. Extruder die assembly 10 includes an extrusion apparatus or cross-head or head 12, a wire guide 14, a support member or die 16 and a cover plate or face plate 18. In accordance with the present subject matter, a wire 19 draws through head 12 for coating of molten plastic or insulating layer over it and exits from head 12.

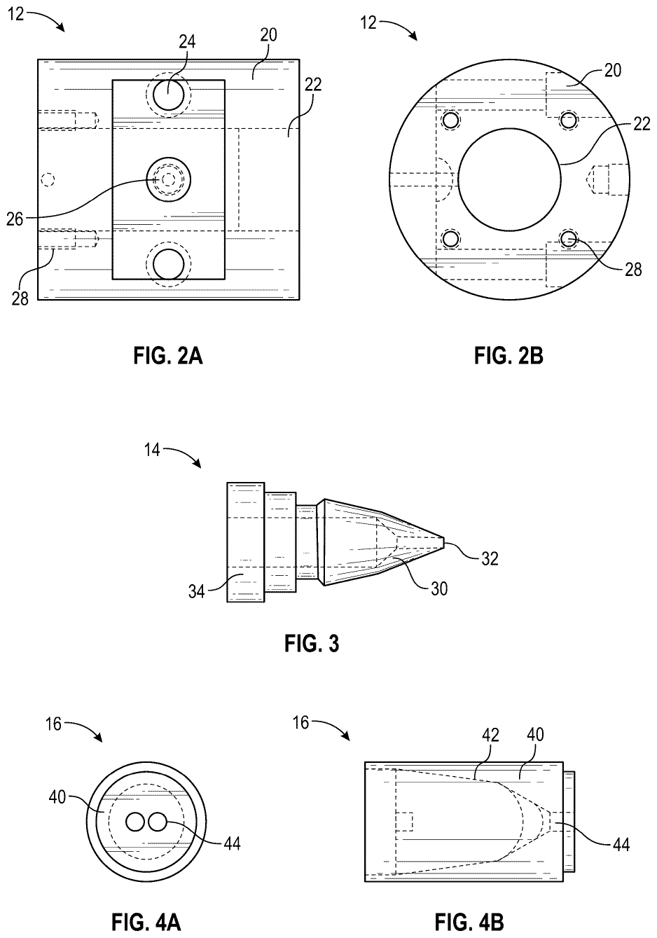

FIG. 2A and FIG. 2B show a top and a side view, respectively of head 12, in accordance with one embodiment of the present subject matter. Head 12 includes a first body 20. First body 20 presents an axial opening or axial bore 22. Axial opening 22 extends along the length of first body 20. Further, first body 20 presents radial openings 24 and a radial bore or injection gate 26. Radial bore or injection gate 26 communicates with a portion of axial opening 22. In one example, radial bore 26 connects at the end to supply molten plastic or other flowable coating material in cross-head 12. In one example, radial openings 24 position at opposite sides of first body 20 and help to connect head 12 in a conventional manner. Further, first body 20 presents connecting holes 28. Connecting holes 28 help to connect face plate 18 at one side of first body 20, as shown in FIG. 1A, for example.

FIG. 3 shows a side view of wire guide or tip 14, in accordance with one embodiment of the present subject matter. Wire guide 14 includes a body portion 30 having multiconductor wire grooves 44. Here, body portion 30 tapers such that multiconductor tip 32 has a smaller diameter than the opposite end of body potion 30. Body portion 30 includes a connecting member 34 at the opposite side of multiconductor tip 32.

In accordance with the present subject matter, extruder die assembly 10 includes die 16. FIG. 4A and FIG. 4B show a side cross-sectional view and a side view, respectively of die 16. Die 16 includes a second body 40 having a wire guide receiving area 42. Wire guide receiving area 42 configures to receive wire guide 14. At one end, second body 40 presents wire grooves 44. Wire grooves 44 indicate two or more cut-sections arranged in a side-by-side relationship, as shown in FIG. 4B. The two or more cut-sections are parallel to each other and spaced relative to each other. The two or more cut-sections are positioned at the center of wire guide 14.

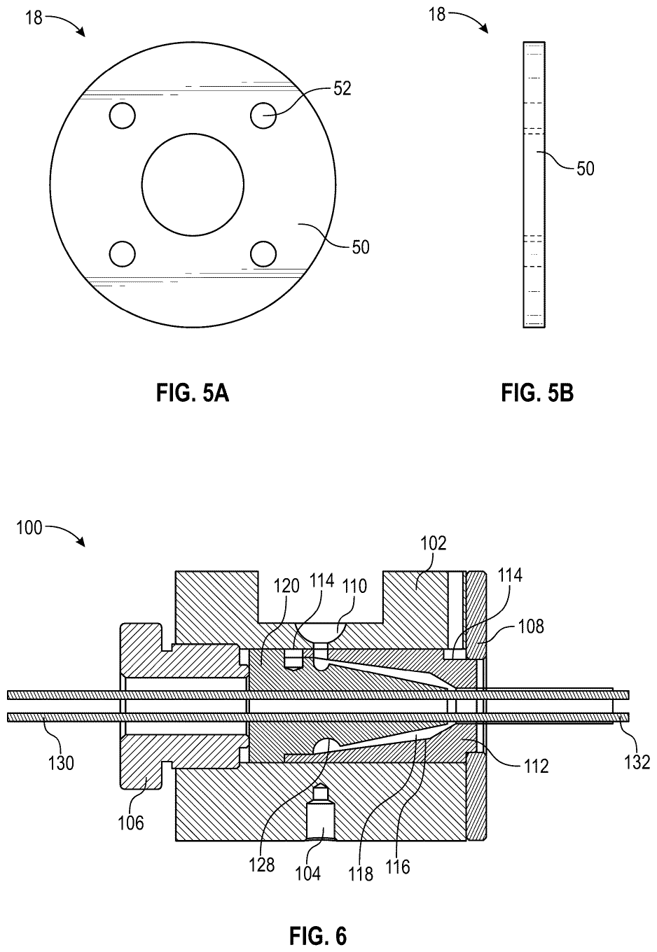

FIG. 5A and FIG. 5B show a front view and a side view, respectively of face plate 18, in accordance with one embodiment of the present subject matter. Face plate 18 includes a circular member 50 having holes 52. Holes 52 align with connecting holes 28 and help to connect face plate 18 to head 12, as shown in FIG. 1A, for example.

In order to provide a multiconductor wire, wire guide 14 is inserted in die 16. Further, die 16 is inserted in axial opening 22. In operation, wire 19 draws through head 12 i.e., via axial opening 22. Here, molten plastic or other flowable coating material is injected through radial bore or injection gate 26 into body 20. The molten plastic gets distributed around wire 19 which is moved axially through guide elements within axial opening 22. Wire 19 moves axially and exits via wire guide 14. Here, wire 19 exits through multiconductor tip 32 in the front end with a uniform coating of the plastic. A person skilled in the art understands that an elevated temperature is maintained for coating material to provide the proper viscosity. In some implementations, electric heating jackets (not shown) might be used to maintain the coating material at elevated temperatures. As specified above, the two or more cut-sections are arranged in a side-by-side relationship and parallel to each other while being spaced relative to each other. As such, when wire 19 exits through multiconductor tip 32, wire grooves 44 make the exiting coated wire 19 to arrange in a side-by-side contiguous relationship to provide contact areas between adjacent coated wires.

FIG. 6 shows a cross-sectional view of an extruder die assembly 100, in accordance with one embodiment of the present subject matter. Extruder die assembly 100 includes an extrusion apparatus or cross-head or head 102. Head 102 configures to receive a die or support member 112. In other words, die 112 sits within head 102. Further, head 102 includes a nut or connecting member 106 at one end, and a face plate or cover plate 108 on the other end. In one embodiment, head 102 encompasses a thermal coupler fitting 104 at one side and an injection gate 110 at other side. Here, injection gate 110 is used to inject molten plastic onto a wire guide 120 and thermal coupler fitting 104 is used to measure temperature of the molten plastic injected.

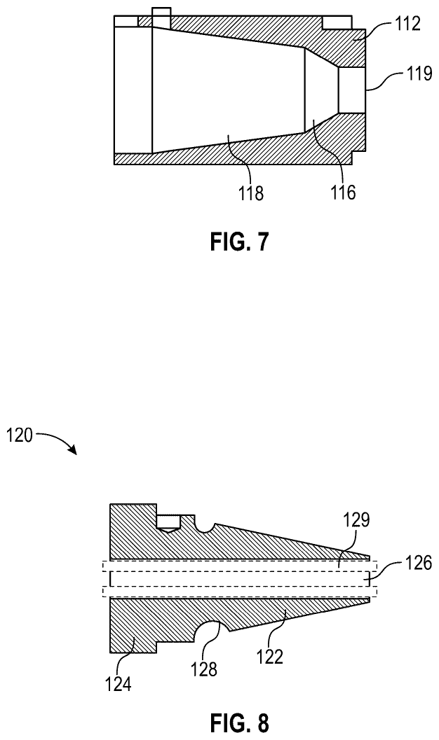

As presented above, die 112 sits within head 102. Die 112 configures to receive a wire guide or tip 120 within. In one example, die 112 encompasses alignment members 114. Alignment members 114 indicate bars used for stabilizing die 112 with respect to both head 102 and wire guide 120. In order to stabilize the die 112, alignment members 114 position at the top of die 112 and help to align wire guide 120 within die 112 and also to align die 112 with respect to head 102. In accordance with one embodiment of the present subject matter, die 112 encompasses a wire guide receiving area 116. Wire guide receiving area 116 indicates a hollow area within die 112. Here, wire guide receiving area 116 has a slightly larger area than the surface area (tapered section) of wire guide 120. As a result, there is a gap 118 formed between wire guide 120 and wire guide receiving area 116 when wire guide 120 sits within die 112. Gap 118 allows molten plastic to flow around wire guide 120 and exit via a groove 119. FIG. 7 shows a cross-sectional view of die 112 having wire guide receiving area 116 at the center and groove 119 at one end, in accordance with one embodiment of the present subject matter.

FIG. 8 shows a cross-sectional view of wire guide 120. Wire guide 120 includes a first section 122 and a second section 124. First section 122 comes in a tapered configuration. Second section 124 comes in a cylindrical configuration. Second section 124 positions at the wider area/section of first section 122. First section 122 encompasses an end section 126. In one example, first section 122 encompasses a filler groove 128. Here, filler groove 128 comes in an elliptical configuration. Filler groove 128 is provided at first section 122 and is made to align with injection gate 110. Filler groove 128 helps molten plastic from injection gate 110 to flow around first section 122. Further, wire guide 120 presents wire grooves 129. Wire grooves 129 indicate two or more cut-sections arranged in a side-by-side relationship, and run the entire length of wire guide 120. In the present subject matter, wire grooves 129 receive wires or bare wires 130 from the end of second section 124, as can be seen from FIG. 6.

Referring back to FIG. 6, the operation of extruder die assembly 100 for providing multiconductor wires is explained. At first, wire guide 120 is inserted in die 112. Die 112 is positioned in head 102 with the help of alignment members 114. This results in positioning wire guide 120 in a fixed manner within die 112. Further, nut 106 and face plate 108 are positioned at distal ends of wire guide 120 and die 112, respectively. Concurrently or consecutively, wires 130 are drawn such that wires 130 pass through wire grooves 129. In order to coat the molten plastic or insulating layer onto wires 130, the molten plastic is injected from injection gate 110 such that the molten plastic flows around wire guide 120. Here, the molten plastic flows in gap 118 formed between wire guide 120 and wire guide receiving area 116. Further, the molten plastic flows around wires 130 under high pressure and elevated temperature as wires 130 travel through die 112 and coat wires 130 with the molten plastic. After coating, coated wires 132 exit from extruder die assembly 100.

The presently disclosed assembly provides several advantages over the prior art. The assembly allows the coated wire to exit via a fixed center multi conductor tooling. The die or wire guide has wire grooves. The wire grooves are arranged in a side-by-side relationship and parallel to each other while being spaced relative to each other. As such, when the wires exit through the wire grooves, they are arranged in a side-by-side contiguous relationship to provide contact areas between adjacent coated wires. When compared with the prior art, the presently disclosed assembly presents a wire guide that acts as a fixed center multi conductor tool.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed subject matter.

What is claimed is:

1. An extruder die assembly for coating wires, said extruder die assembly comprising:
a head comprising an axial opening and an injection gate;
a wire guide positioned within said axial opening of said head, wherein said wire guide comprises holes configured to receive wires; and
a die positioned within said axial opening and configured to receive said wire guide,
wherein said wires draw through and move axially, through said axial opening,
wherein said injection gate injects a coating material into said axial opening to uniformly coat said wires as said wires pass through said wire holes, and
wherein said coated wires exit through said wire guide.

2. The extruder die assembly of claim 1, further comprises alignment members configured to stabilize said die with respect to both said head and said wire guide.

3. The extruder die assembly of claim 1, wherein said die comprises a wire guide receiving area configured to receive said wire guide.

4. The extruder die assembly of claim 3, wherein said wire guide receiving area has a larger area than the surface area of said wire guide creating a gap therebetween said wire guide and said wire guide receiving area, and wherein said gap facilitates flow of said coating material in said wire guide.

5. The extruder die assembly of claim 1, wherein said wire guide comprises a multiconductor tip, and wherein said coated wires exit through said multiconductor tip.

6. The extruder die assembly of claim 1, wherein said wire holes comprise two or more cut-sections, and wherein said cut-sections are positioned in parallel to each other and spaced relative to each other.

7. The extruder die assembly of claim 6, wherein said wire holes configure to arrange said coated wires in a side-by-side contiguous relationship to provide contact areas between adjacent coated wires.

8. The extruder die assembly of claim 1, further comprises a faceplate configured to secure said wire guide and said die to said head.

9. The extruder die assembly of claim 5, wherein said wire guide tapers such that said multiconductor tip has a smaller diameter than an opposite cylindrical end of said wire guide.

10. The extruder die assembly of claim 1, further comprises a thermal coupler fitting, wherein said thermal coupler fitting is positioned on said head, and wherein said thermal coupler fitting is configured to monitor the temperature of said coating material.

11. An extruder die assembly for coating wires, said extruder die assembly comprising:
a head comprising an axial opening and an injection gate;
a wire guide positioned within said axial opening of said head, wherein said wire guide comprises holes configured to receive wires; and
a die positioned within said axial opening, wherein said die comprises a wire guide receiving area configured to receive said wire guide,
wherein said wire guide receiving area has a larger area than the surface area of said wire guide creating a gap therebetween said wire guide and said wire guide receiving area,
wherein said wires draw through and move axially in said axial opening,
wherein said injection gate injects a coating material into said axial opening to uniformly coat said wires as said wires pass through said holes, and
wherein said coated wires exit through said wire guide.

12. The extruder die assembly of claim 11, further comprises alignment members configured to stabilize said die with respect to both said head and said wire guide.

13. The extruder die assembly of claim 11, wherein said wire guide comprises a multiconductor tip, and wherein said coated wires exit through said multiconductor tip.

14. The extruder die assembly of claim 11, wherein said wire holes comprise two or more cut-sections arranged in a side-by-side relationship, and wherein said cut-sections are positioned in parallel to each other and spaced relative to each other.

15. The extruder die assembly of claim 14, wherein said wire holes configure to arrange said coated wires in a side-by-side contiguous relationship to provide contact areas between adjacent coated wires.

16. The extruder die assembly of claim 11, further comprises a thermal coupler fitting, wherein said thermal coupler fitting is positioned on said head, and wherein said thermal coupler fitting is configured to monitor the temperature of said coating material.

17. The extruder die assembly of claim 11, further comprises a faceplate configured to secure said wire guide and said die to said head.

18. A method of coating wires, said method comprising the steps of:
providing a head comprising an axial opening and an injection gate;
providing a wire guide positioned within said axial opening, said wire guide comprising holes for receiving wires;
providing a die positioned within said axial opening, said die configured for receiving said wire guide;
drawing said wires through and moving axially in said axial opening;
injecting a coating material into said axial opening via said injection gate for uniformly coating said wires as said said wires pass through said holes; and
exiting said coated wires through said wire guide.

19. The method of claim 18, further comprising providing alignment members for stabilizing said die with respect to both said head and said wire guide.

20. The method of claim 18, further comprising providing two or more cut-sections at said holes, said two or more cut-sections being arranged in a side-by-side relationship to provide contact areas between adjacent coated wires.
